(19) United States
(12) Patent Application Publication
(10) Pub. No.: US 2006/0230380 A1
(43) Pub. Date: Oct. 12, 2006

(54) Rule-based system and method for registering domains

(76) Inventors: Robert Holmes, London (GB); Huw Stead, Cardiff (GB); Peter Forman, New York, NY (US)

Correspondence Address: AMSTER, ROTHSTEIN & EBENSTEIN LLP, 90 PARK AVENUE, NEW YORK, NY, 10016, US

(21) Appl. No.: 11/101,948

(22) Filed: Apr. 8, 2005

(51) Int. Cl. G06F 9/44

(52) U.S. Cl. 717/117

(57) ABSTRACT

The present invention generally relates to a rule-based system and method for generating domain name orders from domain registrants in a standardized format, as required by a particular domain name registry. This method and system captures the data requirements of the various domain registries for ordering a multitude of different domains, creates a set of API based rules which will guide the user through order entry for a particular domain, and allows domain registrars to associate these rules with a particular domain. Accordingly, the domain registrar can ensure that complete and accurate information and documentation required by a registry of a particular domain to fulfill a domain name order is provided by the do -main name customer when -ordering a domain.

### FIELD OF THE INVENTION

The present invention generally relates to a rule-based system and method for generating domain name orders in a standardized format, as required by a particular domain name registry.

### BACKGROUND OF THE INVENTION

Domain name registries and registrars work together to facilitate the registration of domain names. A domain registry typically maintains a master database of registered domain names and their linked unique internet protocol (“IP”) number or address. At present, there are at least fourteen generic top-level domains (“gTLD”) (e.g., .com, .edu, .biz, etc.) and approximately 243 country code top-level domains (“ccTLD”) (e.g., .us, .uk, and .tv), many of which must be registered with a second-level domain (e.g., .org.uk, .me.uk, and .co.uk). Each of these domains is managed by a registry. When a consumer wishes to register a particular domain name, it will do so through a domain name registrar (e.g., Register.com) which communicates with the domain name registry managing the domain to ascertain whether the domain name being requested by the consumer is indeed available.

Many of various domain registries have different order data requirements for registering a domain name. For example, the registry for the ccTLD “.uk”, currently Nominet (www.nominet.org.uk), has a set of unique and specific order data requirements which differ from the order data requirements of the ccTLD “.us” registry, currently NeuStar, Inc. (www.nic.us). More particularly, customers desiring to register a .us TLD (.us) must be, inter alia, (1) a person who is either: (i) a United States citizen; (ii) a permanent resident of the United States of America or any of its possessions or territories, or (iii) whose primary place of domicile is in the United States of America or any of its possessions; (2) a United States entity or organization that is (i) incorporated within one of the fifty (50) U.S. states, the District of Columbia, or any of the United States possessions or territories, or (ii) organized or otherwise constituted under the laws of a state of the United States of America, the District of Columbia, or any of its possessions or territories (including a federal, state, or local government of the United States or a political subdivision thereof, and non-commercial organizations based in the United States); or (3) a foreign entity or organization that has a bona fide presence in the United States of America or any of its possessions or territories.

In contrast, a customer desiring to register an .uk TLD must meet entirely different requirements than the .us TLD customer. For example, a customer desiring to register the domain “.net.uk” must be an Internet Service Provider and the Domain Name to be registered must be the same as or a similar variant of the customer's name. The registry for the .net.uk domain deems a customer to be an Internet Service Provider if it is, for example, (1) listed on the Register of Companies at Companies House in Great Britain under the Companies Act 1985; it is listed on the Register of Companies at the Northern Ireland Companies Registry under the Companies (Northern Ireland) Order 1986; or, it is a partnership as defined by the Partnership Act 1890, Limited Liability Partnerships Act 2000 or a sole trader; and, (2) is listed as a local internet protocol (IP) address registry with a regional IP address registry; or, has an Autonomous System containing hosts in the United Kingdom that is listed with a regional IP address registry and that is continuously or at all reasonable times reachable from major Internet exchange points.

The foregoing are just a few examples of the many differences in domain order data requirements for the respective registries of the .uk TLD and the .us TLD. The differences in domain name registration requirements among the 243 ccTLD registries and 14 gTLD registries are too vast to list herein, although this information could be readily obtained from publicly available sources, such as a registry's website and/or guidelines published by The Internet Corporation For Assigned Names And Numbers. Given the numerous registries and differing registration requirements, the registrar must be intimately familiar with each domain registry's current order data requirements, must keep apprised of any changes in these requirements and must ensure that their customer's provide information and documentation which meets these requirements when placing domain name orders.

A long standing problem in the domain name ordering process is the inability of registrars to efficiently deal with the complexities and differences among the various registries' domain registration requirements in such a way that streamlines the domain name ordering process. Part of the problem is attributable to the fact that registrars have not provided an effective domain ordering system which adequately assists their customers in providing complete and accurate information as required by registries. Even where registrars have provided their customer's with some degree of guidance in placing domain name orders, many customers fail to follow this guidance and do not provide the registrar with the information required by the registry to register a domain.

More particularly, in the past, when a customer applied for a particular domain name, he or she rarely provided a complete order in the format that is required by a registry. This was because the registrar had little control over the format in which customers provided information when placing orders for domain names. Accordingly, after receiving an order, the registrar would need to conform each domain name order to the requirements of the pertinent domain registry. To do so, the registrar would first collect basic information relating to the customer (e.g., name, domain name, place of business, residency and citizenship information, etc.). This information was rarely in the proper format, and often incomplete, and thus did not meet the registration requirements of the relevant domain registry. As a result, the registrar would often go back to the customer and request further information. In some cases, the employees of the registrar seeking this additional information were not intimately familiar with the various registry domain order requirements, and thus, would fail to retrieve all of the information required to complete an order. Thus, even further communications with the customer were required to fulfill the requirements of the registry. Once all of the required domain order information was obtained from the customer, the registrar would convert this information to a format that was acceptable to the relevant registry. This process was tedious and was often performed manually or via emails. Thereafter, the registrar would forward the customer's order to the relevant registry for approval. If the person who entered the customer's registration data made any errors (e.g., typographical errors), further delays in the domain registration process would result.

While the prior art methods are somewhat useful, they do not allow for efficient completion of domain orders in the proper format, as required by domain registries. Thus, there is a long-felt need for a standardized method of obtaining domain orders which meets a registry's registration requirements while at the same time minimizes the inefficiencies associated with the prior art.

### SUMMARY OF THE INVENTION

While the prior art is of interest, the known methods and systems of the prior art present several limitations which the present invention seeks to overcbn me. Thus, it is an object of the present invention to provide a rule-based system and method for automatically generating a domain name order in the proper format required by the registry for that domain, wherein order entry rules are associated with a particular domain so as to guide a user through the order entry process.

It is another object of the present invention to provide a rule-based system and method for generating domain name orders, wherein rules associated with a particular domain can be easily updated and modified to conform to changes in a domain registry's requirements for registering a particular domain.

It is another object of the present invention to provide a rule-based system and method for generating domain name orders in a timely and efficient manner.

It is another object of the present invention to provide a rule-based domain name order system and method for reducing data entry errors associated with conventional domain order methods.

It is another object of the present invention to solve the shortcomings of the prior art.

Other objects will become apparent from the foregoing description.

It has now been found that the above-related objects of the invention are obtained in the form of a rule-based method for generating domain name orders in a specific form. This method comprises the steps of: creating a list of domain extensions which could be registered; generating domain name order entry rules, wherein the rules comprise constraints which require domain order information to be provided in a format required by at least one registry of a domain on the list of domains; storing the set of rules separate from the list of domains; and associating any of the rules with at least one domain in the list of domains. In one embodiment of the present invention, the set of rules are organized by one or more of the following rule types: template rules; additional information rules; select-from rules; document rules; and check-box rules.

The present invention is also directed to a rule-based system for generating domain name orders in a specific format. This system comprises, among other things: a server interfaced to a network, wherein the server comprises storage media; a list of domain extensions stored on the storage media; and domain order entry rules stored separately from the list of domains on said storage media. The rules of the present invention comprise constraints which ensure that a registrant provides information in a format required by at least one registry of a domain on the list of domains. Additionally, the system includes a graphical user interface for creating and editing the rules and the list of domains. In one embodiment, the system of the present invention further comprises a graphical user interface for guiding a domain name registrant through an order entry process.

In one embodiment of the present invention, the graphical user interface for associating domain extension order entry rules with domain extensions comprises: a domain extension page for creating and editing a list of domain extensions which can be registered, wherein the domain extension page is interfaced to a list of domain extensions stored on the server; and a rules page for creating and editing rules which govern the manner in which domain name order data can be provided. The rules page is interfaced to a table of rules stored on the server, and is configured to associate a rule stored in the table of rules with domain stored the list of domain extensions.

In an embodiment of the present invention, the graphical user interface for entering a domain name order comprises: a search page for searching for at least one domain extension to be registered; and a page for entering domain order information for a domain to be registered. The page for entering domain order information is interfaced to a list of rules associated with the domain to be registered. Additionally, the page for entering domain order information comprises at least one prompt which require a domain name applicant to comply with rules on the list of rules to complete a domain name order.

### BRIEF DESCRIPTION OF THE DRAWINGS

The above and related objects, features and advantages of the present invention will be more fully understood with reference to the following detailed description of the preferred, albeit illustrative, embodiment(s) of the present invention when considered in conjunction with the accompanying figures, wherein:

FIG. 1 is a screen-shot of the graphical user interface (“GUI”) for searching for drop down menus stored on the system of the present invention;

FIG. 2 is a screen-shot of the GUI for editing the drop down menus retrieved in the GUI shown in FIG. 1;

FIG. 3 is a screen-shot of the GUI used for searching for rules stored on the system of the present invention;

FIG. 4 is a screen-shot of the GUI used to edit rules located via the GUI of FIG. 3;

FIG. 5 is a screen-shot of the GUI used to search for a domain/product pair stored on the system of the present invention;

FIG. 6 is a screen-shot of the GUI used to edit a domain/product pair located via the GUI of FIG. 5;

FIG. 7 is a web page through which a customer can enter domain order information;

FIG. 8 is a web page linked to the web page of FIG. 7, through which a customer can enter additional order information; and

FIG. 9 is a web page which advises a customer of errors made during the order entry process.

### DETAILED DESCRIPTION OF THE PREFERRED EMBODIMENT(S)

The present invention generally relates to a rule-based application program interface (“API”) which includes routines and constraints which ensure that registrars are requiring their customers to accurately provide all of the information and documentation required by the various domain registries to fulfill a domain name order. The rules of the present invention are created and stored separately from a list of domains which can be registered. Having knowledge of the domain order data requirements of the various registries, an operator of the system of the present invention can select any of the rules and associate them with a particular domain on the domain list. By storing the rules and domain names separately, the domain name registrar can also update the rules to conform to changes in a registry's domain registration requirements and allow for new rules and domains to be added as new domains are offered for sale. A GUI, e.g., a web page, is provided to the customer in which a series of text fields, check boxes, drop down lists, pop-up windows, etc. are interfaced to the rules for a particular domain. The GUI, together with the rules, guides the user through the domain name order process in such a way that orders cannot be submitted unless the order-related information satisfies the relevant registries domain registration requirements. Each of these aspects of the present invention is discussed in detail below.

Preferably, the software of the present invention is implemented on a client-server system, wherein the server has storage media, including, for example, a relational database, an XML file, an object-oriented class or other similar storage media now known or hereinafter developed. The client (e.g., a computer of a registrar's customer), through interaction with a GUI, connects to the server, and is prompted by the rules of the present invention to provide all of the domain order data to the registrar in a format which meets the requirements of the registry for the domain name being registered. The software based application of the present invention is preferably implemented on an Internet website, or alternatively, can be installed locally on a customer's computer.

To understand the functionality of the software of the present invention, a description of the manner in which rules and domain names are stored and organized is first described. Generally speaking, a list of domains (and related products) is stored in a relational database on the server. Similarly, a table of API-based rules, which are based on the registration requirements of the registry for each domain on the list of domains is stored in a separate relational database. As discussed below, any of the stored rules can then be associated with any of the stored domains. The generation and storage of the list of domains and rules are each discussed below.

In one embodiment of the present invention, a list of domains and related products for each domain which can be registered by a customer (hereinafter, referred to as a “product restrictor list”) is created and stored in a relational database on the server. This step is preferably performed by a registrar, but of course could be performed by a registry or some other person or entity. In a preferred embodiment, the product restrictor list includes two components: a table of domains and related products; and a search filter.

Turning first to the table of domains and related products, it should be understood that a registry's requirements often vary for different product types for the same domain extension. Order types could include, for example, registrations of domains, renewals of registrations, modifications to existing registrations, lapses in registrations, gTLD transfers in, ccTLD transfers in and transfers out. Accordingly, the table of domains is organized to include all possible domains extensions (e.g., all known gTLDs, ccTLDs and second-level ccTLDs) and their associated order types (e.g., registrations, modifications, transfers, etc.). In other words, the table of domains and related products preferably includes a separate entry for each domain/product pair.

An example of the table of domains and related products is provided in Table 1 below:

TABLE 1

| Domain Extension | Product Type | Domain Type |
|---|---|---|
| .com | Registration | gTLD |
| .com | Modification to | gTLD |
| | registration | |
| .com | Transfer in | gTLD |
| .kids.us | Registration | ccTLD (United States) |
| .kids.us | transfers in | ccTLD (United States) |
| .kids.us | transfers out | ccTLD (United States) |
| .co.uk | Registration | ccTLD (United Kindom) |
| .co.uk | modifications to existing | ccTLD (United Kindom) |
| | registrations | |
| .co.uk | renewal | ccTLD (United Kindom) |

Using the search filter in the product restrictor list, a user (e.g., a system administrator) can search for a particular domain/product pair in the domain table. The search filter should be configured such that the user can search by one or more of the following categories: domain extension, country and product type. To search by domain extension, a text box could be provided in which a Boolean or free-text search is performed. For a country search, a drop down menu having a list of countries could be provided to select from. For a product type search, check boxes are provided with a list of product types (e.g., registration, modifications, etc.) which could be selected. Additionally, a default to search all product types can also be performed.

Additionally, it should be noted that the table of domains and related products should be configured so that it can be updated with new domains and products as they are offered by registries, and be edited to account for any changes in existing requirements. In one embodiment, an edit link may be provided which allows the user to add rules, update rules or remove rules from the selected product. To facilitate the editing process, in one embodiment, the table of domains can be sorted by extension, product type and country name. Additionally, the search filter can be used to locate a particular domain/product pair.

A separate list of API-based rules (hereinafter referred to as “the Rules Catalog”) is maintained in a separate relational database. In one embodiment, the Rules Catalog includes three components: a table of rules; a search filter; and a hyperlink to create a new rule, or edit an existing rule. Each of these components is now described.

For each of the various domain/product pairs, it is possible that there are different rules required by the registries for making a domain name order. Thus, a table of API-based rules is created which accounts for all the different variations of these requirements. It should be noted that the rules can be written in other similar object oriented languages, including, for example, Java or C++. These rules include routines and constraints which specify acceptable responses which meet the requirements of each registry for registering a domain or product selected from the product restrictor list. As discussed in more detail below, the rules are preferably stored in a relational database on the server that is separate and different from the relational database in which the product restrictor list is stored, so that each rule can be individually associated with a particular domain/product pair on the product restrictor list.

The manner in which rules are generally organized and stored within the table of rules is now discussed. In one embodiment of the present invention, the rules are classified and stored by the following five general rule types: (1) template (“T”); (2) document (“D”); (3) additional information (“AI”); (4) select-from (“S”); and (5) check box (“C”). These rule types include categories of information which are universally required by the various domain registries to register a domain. For each rule-type, a subset of object oriented rules which specifically relate to the type and format of domain order data (e.g., information and documentation) which is acceptable to each registry for the domains/product pairs stored in the product restrictor list are created. In other words, these rules include constraints which govern the entry of a customer's information and documentation during the domain order process, as described below.

More particularly, each of the registries requires certain standard information relating to the domain name application. For example, detailed information is typically required for the following types of “Whois” contacts: registrant name, administrative contact, technical contact and billing information. Domain applications also need to specify the name of the servers to which a successful domain order should be delegated. Certain registries may impose format or value limitations on the manner in which they will accept Whois information. Accordingly, in a preferred embodiment, for each domain/product pair in the product restrictor list, a subset of object oriented rules are classified as “template” rule types and are configured to include constraints which require that the customer provide the Whois information in the format specified by the relevant registry.

By way of example, in configuring object oriented rules for the Whois template for the .fr extension, the relevant registry may require that: the customer's administrative contact must be a named person and that the associated company is registered locally. In contrast, to register a domain name under the .ltd.uk extension, the relevant registry may require the applicant to provide a contact address having a valid United Kingdom postal code. Accordingly, object oriented rules should be established which ensure that the limitations imposed by the registry for template rules (e.g., Whois information) are met by customers. In this regard, a value or format constraint should be imposed for each required field of Whois information (e.g., registrant name, administrative contact, technical contact, billing information). These constraints govern what type of information can be entered by a customer, and thus, ensure that a registry's requirements are met. It should be noted that the present invention is not limited to these examples, as the Whois template should include constraints which cover all of the different possible restrictions as to acceptable Whois information to the various registries for domains stored in the product restrictor list.

Moreover, certain registries may have common requirements for information required by the template rule type category, or any other rule type category. Thus, once a rule is created for a particular registry's requirement that is common to other registries, it is not necessary to duplicate those rules for the other registries requiring the same rule. Rather, a generic rule could be used to accommodate all of the registries having common requirements for a particular category of information. For example, if a “local administrative contact” is required by multiple registries, a generic rule could be implemented by which the country associated with a particular extension will require that the administrator's contact country must be the same as the extension's country value.

To register a domain, many registries also require certain documentation from the applicant. These documents may include, for example, a company registration certificate, a certificate of incorporation, a letter of assumption of responsibility, a power of attorney and other registry-specific forms, to name a few. According to the present invention, for each domain/product pair in the product restrictor list, a subset of object oriented rules are classified as “document” rule types and are configured to require the customer to provide the specific documentation required by each relevant registry. These rules can further specify the format (either original or electronic) in which this documentation will be accepted. In one embodiment, the document rules could be configured to allow for a customer to browse his or her computer and attach an appropriate document. In one embodiment, a sample document is associated with the rule of a particular registry such that it could be displayed when a user is entering information into this category. This will assist the user in understanding the type of document required to complete registration of the domain.

Additionally, each registry may require additional information which is not necessarily required by other registries. This additional information could include, for example, non-standard information, such as a trademark name, trademark registration date, trademark registration number, company registration numbers and authorization-codes (.e.g., domain-specific identification numbers used by EPP registries such as Afilias (.INFO) and NeuLevel (.BIZ) to authenticate modification and renewal orders). According to the present invention, for each domain/product pair in the product restrictor list, a subset of object oriented rules are classified as “additional information” rule types and are configured to require the customer to provide the specific non-standard, additional information required by each relevant registry. The rules should include constraints which ensure that the additional information requirements of each registry of the registries are met. In one embodiment, a label, such as “Registry of Companies number,” is associated with each rule for the additional information rule type and a box is provided through which customers can provide responses when ordering a domain name.

Some registries require the additional information to be provided in a particular format, such as free text or date format. In a preferred embodiment, regular expression format constraints are used to ensure that the user enters the additional information in the specified format. As a result, these constraints make it is possible to control the manner in which a customer inputs the additional information in a free-text field in the GUI. For example, sunrise applications for the ccTLD .kids.us domain were only available to trademark holders and were only accepted if the associated trademark was registered before Dec. 31, 2002. In this case, the additional information rule name would be “trademark registration date” and the rule for a valid response would be set as a date format which must have a value of less than Dec. 31, 2002.

Additionally, a registry may require certain information for which there are limited number of acceptable responses. For example, to register a domain name under the us TLD, applicants must indicate what type of organization they are and also their Nexus category. The only valid Nexus classifications for this domain are: (a) US citizen, (b) Permanent resident, (c) US organization, (d) Foreign organization doing business in US and (e) Foreign organization with US office. According to the present invention, for each domain/product pair in the product restrictor list, a subset of object oriented rules is classified as “select-from” rule types and are configured to ensure that one of the acceptable responses required by the relevant registry is provided by the user. In one embodiment, to allow a user to make choices as to the information to be provided, select-from lists are provided as a drop down menu in the GUI, which allows the customer to select which information is to be entered, as described in greater detail below.

For example, the registry for the .es domain extension requires that, if the domain is based on a trademark, the registrant must provide the trademark name, number and registration date. In this example, a rule is established which prompts a customer to indicate (e.g., by a yes/no response) whether or not the .es registration is based on a trademark. Thereafter, the relevant rules in the additional information rule type for the .es domain extension will govern the entry of information pertaining to the trademark.

Many registries offer automation capabilities which require that certain data be submitted as part of the domain name order transaction. Often this data is submitted as a code that is meaningless to consumers but nevertheless required as part of the order. According to the present invention, in one embodiment, the select-from rules could be configured with descriptions and underlying code values that automatically require customers to select the required code value to satisfy the automation requirements of the registry. For example, the Nexus categories described above map to codes recognized by the registry's automation engines. A value of “Foreign organization doing business in US” maps to a Nexus code of C31; equally, a country value of “United Kingdom” maps to an ISO country code of GB.

Finally, each registry may require that the customer agree to certain terms and conditions through their registration and use of a domain. According to the present invention, for each domain/product pair in the product restrictor list, a subset of object oriented rules are classified as “check box” rule types and are configured to require the customer to check off a box to indicate their agreement to the terms and conditions specified by the relevant registry. In some cases, it may be necessary for the registrar to certify that customer has met the requirements of the registry. For example, it may be difficult to interface with external data sources to verify whether a customer has complied with the .no registration constraint that companies are only allowed to register a maximum of 20 such domains. Similarly, some countries, such as Algeria, Macau and Peru, require customers to specify in their domain applications the name of the servers that are physically located in those countries. Thus, where upfront verification that a customer has satisfied a rule is not feasible, the check box rules should be configured to at least require the customer to acknowledge their duty to comply with the limitations imposed by the relevant registry.

In a preferred embodiment of the present invention, the rules are organized as a hierarchy of components and subcomponents, wherein each component and subcomponent is defined by the requirements of a particular domain registry. Each of these subcomponents may have further detailed subcomponents (“child components”). For example, a customer desiring to register an us TLD might indicate that it is a foreign entity doing business in the United States. This response to the parent nexus registration requirement prompts a child rule to obtain additional information regarding the Country of Incorporation from the customer. Depending upon the requirements of the registry of a particular domain, these child components may have additional subcomponents, which in turn can have their own subcomponents, etc. For example, the customer could be further prompted to attach a Certificate of Incorporation. Each component and subcomponent is defined by a set of attributes (e.g., real number, date, character length, and format) which are constraints on the type of data which can be entered. By establishing rules in a parent-child relationship, the customer is provided with the flexibility of optional paths through which they can satisfy a particular rule, while at the same time requiring the customer to provide all of the information necessary to complete an order in a proper format, as required by a registry.

Having knowledge of the rule type categories of the present invention and the specific domain registration requirements of the registry for each domain on the product restrictor list, a skilled programmer could readily program specific object-oriented rules for each rule type in accordance with the registration requirements of the registries for the domain/product pairs on the product restrictor list. In one embodiment of the present invention, these rules are stored and organized in a table of rules which includes the following fields: Rule ID (“RID”); Rule Name; Rule; Rule Type and Products Associated with the Rule. Additionally, an edit link which allows the system administrator to edit or delete rules may be optionally provided. Of course, if desired, any rules can be hard-coded to preclude editing. An example of the table of rule the present invention is provided below:

TABLE 2

| | | | | Prod- |
|---|---|---|---|---|
| | | | | ucts |
| | | | | Asso- |
| | | | | ciated |
| | Rule | | Rule | With |
| RID | Name | Rule | Type | Rule |
| R001 | Local | In order to qualify to register | Tem- | {List} |
| | Adminis- | (or to modify or transfer) | plate | regis- |
| | trative | under the extension, | | trations, |
| | Contact | applicants must specify an | | modifi- |
| | | administrative contact that is | | cations, |
| | | based in the top-level | | trans- |
| | | domain's associated country | | fers |
| R002 | UK | Applicants must prove that | Addi- | .ltd.uk |
| | company | they are a UK company by | tional | regis- |
| | regis- | supplying a valid “Companies | Infor- | trations, |
| | tration | House” incorporation number | mation | .co.uk |
| | number | | | regis- |
| | | | | trations |
| R003 | Trademark | Applicants must demonstrate | Addi- | {List} |
| | regis- | that they have a registered | tional | regis- |
| | tration | trademark that relates to the | Infor- | trations |
| | date | domain they wish to register. | mation | |
| | | Alternatively, it may be that | | |
| | | only trademarks registered | | |
| | | before a particular date | | |
| | | qualify. In both cases, a | | |
| | | trademark registration date is | | |
| | | required against which the | | |
| | | application can be validated | | |
| R004 | US Nexus | Nexus is a US classification of | Select- | .us |
| | infor- | business. To qualify to | From | regis- |
| | mation | register under certain | | trations, |
| | | extensions, applicants must | | .kids.us |
| | | specify whether they are a US | | regis- |
| | | citizen, a US organization, a | | trations |
| | | foreign organization doing | | |
| | | business in the US or a | | |
| | | foreign organization with an | | |
| | | office in the US. | | |
| R005 | French | Only French companies | Docu- | .com.fr |
| | company | qualify to register under this | ment | regis- |
| | regis- | extension. To prove that | | trations, |
| | tration | applicants have offices | | .fr |
| | certifi- | registered in France, | | regis- |
| | cates | applicants must supply | | trations |
| | | French company registration | | |
| | | certificates which the registry | | |
| | | will validate before approving | | |
| | | the registration. | | |
| R006 | Local | Most ccTLD registries require | Check | .com.dz |
| | DNS | applicants to have configured | box | regis- |
| | re- | a registry-specific zone for the | | trations, |
| | quired | domain on the target name | | modifi- |
| | | servers specified before they | | cations |
| | | will approve an application | | and |
| | | for registration or transfer of | | trans- |
| | | DNS. In addition, some | | fers |
| | | registries require the name | | |
| | | servers to be hosted locally | | |
| | | (i.e. in the country associated | | |
| | | with the extension). | | |

It should be noted that Table 2 is merely an abbreviated example of the table of rules of the present invention and that this table is intended to be a comprehensive list of rules and related information for all domain/product pairs stored in the product restrictor list.

Additionally, a search filter (e.g., a search engine) is provided in the Rules Catalog to allow a user (e.g., system administrator) to search the table of rules. The search filter is preferably configured such that the user can search the table of rules by rule name, rule ID and rule type. In the case of a rule name search, in one embodiment, a text field could be provided wherein a wildcard search could be performed against the rule name field. In a rule ID search, a text box could be provided in which the user searches by a particular rule ID number. In a rule type search, check boxes could be associated with various rule types (e.g., a check box for document rules, additional information rules, template rules, select-from rules and check box rules).

The create new rule component of the Rules Catalog allows new rules to be added to the table of rules or existing rules to be edited. In one embodiment, a drop down menu is provided which allows the user to specify which type of rule they wish to create or edit (e.g., a template, document, additional information, select-from or check box). To add rules, the user is first prompted to select the rule type that they wish to apply to the product. Once a rule type is selected, a list of all the corresponding rules for that rule type is displayed. A user may then add a rule to this list or edit an existing rule on the list. Once a rule is added, the user can save the rule and return to the product screen, or add another rule. If any of the rules are hard-coded, then the user will not be able to edit such rules.

The manner in which rules within each rule type may be accomplished is now described. In one embodiment, the template rules could be edited to: create a new and unique rule name; indicate the format of a valid response; create constraints associated with the response; and provide associated notes. Additionally, rules under the document rule type rules could be edited to: create a new and unique rule name; to indicate whether or not the document can be provided by the customer when placing the order (e.g., a rule which requires a yes/no response); and to provide associated notes. For the additional information rule type, the user can: create a new and unique rule name, indicate the format of a valid response (e.g., free-text and date format); create constraints associated with a free-text format response; and provide associated notes. For the select-from rule type, the user can: create a new and unique rule name; indicate the format of the rule (e.g., “country,” “yes/no,” and “other”); and provide associated notes. Similarly, existing check box rules can be edited to change the rule name, caption, description, notes, rule audience and failure messages.

Having described the product restrictor list and Rules Catalog, the manner in which rules from table of rules are associated with a particular domain or related product in the table of domains is now described. As discussed above, the Rules Catalog and product restrictor list are preferably stored separately. By storing these components separately, a user (e.g., the registrar's system administrator) can select a domain/product pair from the product restrictor list and associate with it any particular rule in the table of rules. Thus, having knowledge of the domain registration requirements of each registry, the user can create a table which associates all of the relevant rules of the registry for each domain/product pair stored in the product restrictor list. These rules, when associated with a particular domain, ensure that a complete domain order is generated in a the format that is required by the relevant registry.

The following is an example of a table in which some of the rules in Table 2 have been associated with some of the domain/product pairs in Table 1.

TABLE 3

| Domain | Product | Domain | Rules | |
|---|---|---|---|---|
| Extension | Type | Type | Applied | |
| .com | Registration | gTLD | R001, | Edit |
| | | | R003 | |
| .co.uk | Registration | ccTLD | R001, | Edit |
| | | (United | R002, | |
| | | Kindom) | R003 | |
| .com.fr | Registration | ccTLD | R001, | Edit |
| | | (France) | R003, | |
| | | | R005 | |
| .kids.us | Registration | ccTLD | R001, | Edit |
| | | (United | R003, | |
| | | States) | R004 | |
| .info | Transfer | gTLD | R001, | Edit |
| | | | R003 | |

As shown in Table 3, in addition to having a number of different rules associated with each domain/product pair, it is also possible to edit the table to add additional rules, modify rules or delete rules. In this regard, since the table of rules is stored separately from the table of domains, the rules can be revised to account for any changes in registration requirements made by a registry, and new rules can be added as they are developed. Thus, if a registry changes its registration requirements, a system administrator can access the table of associated rules and domains, select the relevant domain and remove or add any of the rules previously associated therewith. For example, if a registry's requirements are set to change at a particular date, the rules of the present invention could be configured to be valid from a particular start date to a particular end date.

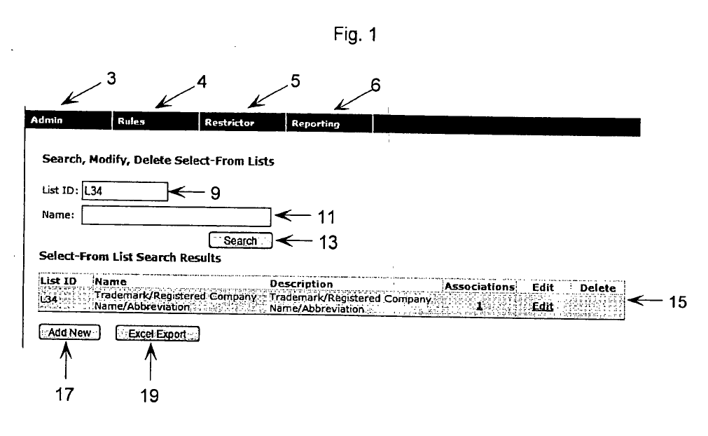

In one embodiment of the present invention, the system administrator (e.g., the registrar) uses a GUI to associate rules from the Rules Catalog (e.g., Table 2) with products in the product restrictor list (e.g., Table 1), and to edit lists which have already had rules and domain/product pairs associated with each other (e.g., Table 3). In this embodiment, the GUI includes four functional components: an Admin tab 3; a Rules tab 4; a Restrictor tab 5; and a Reporting tab 6, as shown in FIGS. 1-6.

The Admin tab 3 of the GUI allows the user (e.g., system administrator) to perform a variety of functions. In particular, the system administrator is able to search for existing domain extensions and input new extensions and product types into the product restrictor list as they are offered. Additionally, the user is able to add, edit or browse the regular expression constraints stored in the Rules Catalog. Using the Admin tab 3, the user can also create generic check boxes where needed. Additionally, the user has the ability to control the mapping of a template field for a particular template rule.

Furthermore, the Admin tab 3 allows a user to associate a “select-from” rule in the Rules Catalog (e.g., Table 2) with a particular drop down menu which is necessary for the customer to comply with that rule, as shown in FIG. 1. For example, if the select-from rule requires the customer to provide his or her trademark information and company name, the user can associate the rule for that requirement with a drop down menu of options to carry out that rule. Referring to FIG. 1, the user can search for a drop-down menu by entering the relevant information in a drop down “List ID” search field 9, or drop down menu “Name” search field 11 and then pressing a search button 13. Matching “Select-From List Search Results” are displayed in a table 15, which in this embodiment, includes the “List ID” number (e.g., L34) and the list's “name” and “description” (e.g., “Trademark/Registered Company Name/Abbreviation”). Additionally, a field with the caption “Associations” is provided to indicate the number of rules associated with the drop down menu (e.g., list ID L34). In this embodiment the Associations number is provided as a hyperlink to the actual rule(s) associated with the drop down menu. Additionally, an “edit” hyperlink allows the user to edit the drop down menu. Additionally, the user can delete the drop down menu, if desired. Additionally, Add New button 17 is provided for adding new drop down menus to the select-from list and an “Excel Export” is provided to export the search results to another application, such as Microsoft Excel®.

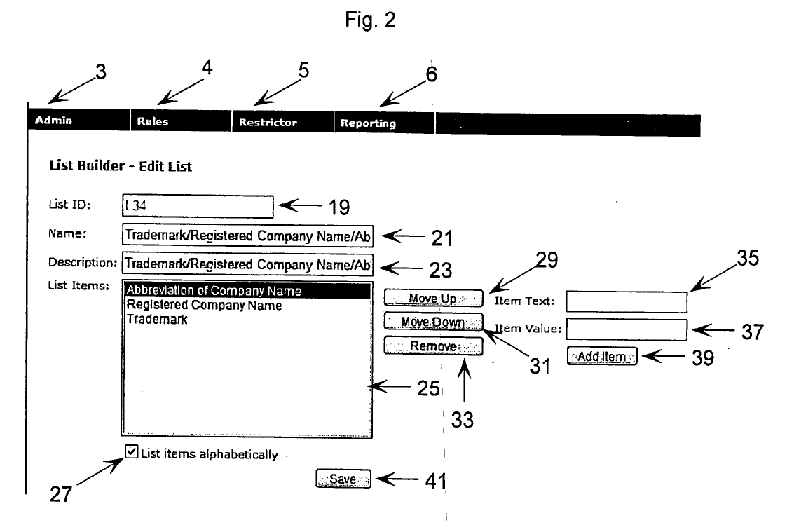

If the user chooses to edit the select-from list from the search results in table 15, then the user is linked to a page on the GUI in which the List ID Number, Name and Description of the select-from list being edited are displayed. Referring to FIG. 2, in this embodiment, the List ID Number L34 and its corresponding name and description (e.g., Trademark/Registered Company Name/Abbreviation) are displayed in List ID field 19, Name field 21 and Description field 23, respectively. Additionally, the drop down menu options for the relevant select-from list are displayed in the List Items field 25 (e.g., “Abbreviation of Company Name”, Registered Company Name” and “Trademark”). Each of the items on the List Items field 25 can be sorted alphabetically by checking a “List Items Alphabetically” check box 27, or arranged in any order by using the “move up” button 29 or the “move down” button 31. Likewise, any item can be deleted from the List Items field 25 using the Remove button 33.

Additionally, the user can assign a user friendly text description to an item in the List Items field 25 and assign an underlying code value for that description using the Item Value field 39. For example, if a registrar requires the customer to select a country of incorporation, to make the drop down menu user friendly, the country could be described in a user friendly manner, such as “United Kingdom.” However, since the registry for .uk registrations currently requires that the country code be in an ISO format, the underlying code value of “GB” will be assigned to the United Kingdom description. This information is added via an “Add Item” button 39.

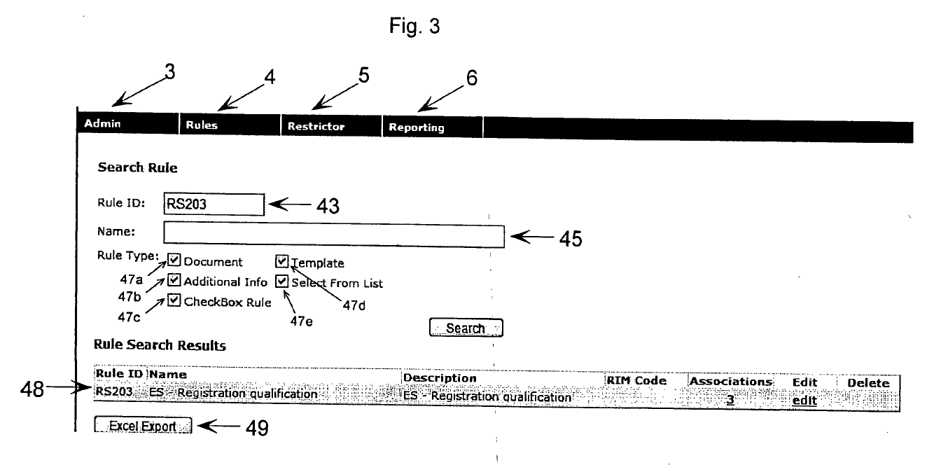

The Rules tab 4 on the GUI allows the user to search for rules in the Rules Catalog (e.g., Table 2), and add rules (e.g., template, additional information, select-from, document, and check box rules) to the Rules Catalog. In this regard, a user can search for a rule in the Rules Catalog by rule ID number, rule name (e.g., a wildcard search) or by rule type, as shown in FIG. 3. In this embodiment, a “Rule ID” search field 43 and “Rule Name” search field 45 are provided in which the user can search by Rule ID number (e.g., RS203) and Rule Name (e.g., ES-Registration Qualification), respectively. Additionally, Rule Type check boxes 47a-47e are provided for each rule type. A search can be performed using any combination of these search fields. Upon performing a search, a list of matching rules is displayed. In this embodiment, the search results are displayed in a table 48 in which the Rule ID number, Rule Name and Rule Description are provided. Additionally, a Registry Interface Module (“RIM”) Code field is provided, which in this embodiment, is a data packet which identifies the rule name and rule-type being satisfied. This data packet is written in a format which can be read by a registry's automation system, if one is used. Moreover, the number of products associated with the particular rule is displayed (e.g., the Number 3) along with a hyperlink to the actual domain/product pairs associated with that rule. Additionally, the user is provided with ability to edit the rule via an edit hyperlink. Likewise, the user can delete the rule. Additionally, these search results can be exported to another application (e.g., Microsoft Excel®) via the Excel Export button 49.

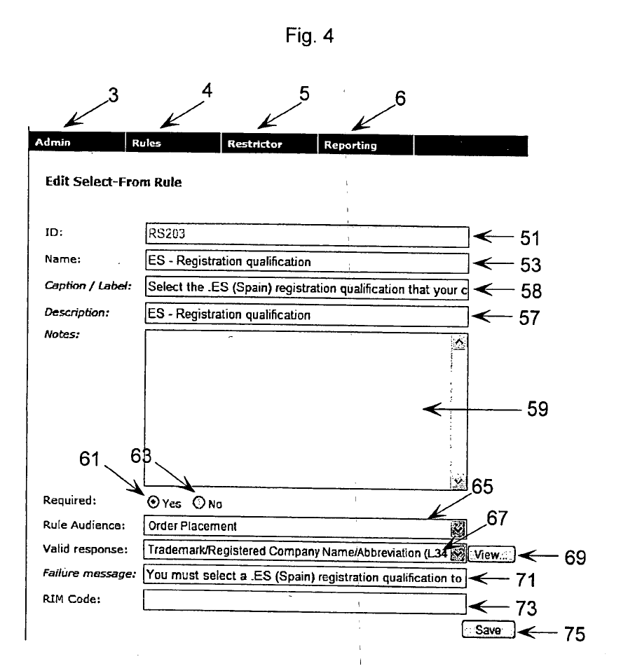

If the user chooses to edit the rule, in this embodiment, an Edit Rule page is displayed in the GUI, as shown in FIG. 4. Information identifying the rule is displayed in a Rule ID field 51, Name field 53, Caption/Label field 57 and Description field 59. In this embodiment, the rule relates to the domain extension “es”. The user is provided with the ability to edit the description in the Caption/Label field 57, if desired. Additionally, the user can add comments relating to the rule in a free text Notes field 59. “Yes” and “No” check boxes 61, 63, respectively, are provided for indicating whether satisfaction of the rule being edited is required to be met by a customer ordering a domain. Additionally, a Rule Audience drop down menu 65 is provided. In this embodiment, the user can select-from one of two choices from the Rule Audience drop down menu 65: (1) “Order Placement;” and (2) “Order Fulfillment.” Order Placement refers to the situation where the entry of order data is required from a customer. In those cases where the registry's requirements are overly complex and burdensome to a customer, the user can specify that the Order Fulfillment (e.g., order processing department of the registrar) must satisfy this rule.

Additionally, a Valid Response drop down menu 67 is provided from which the user can select a valid response which would satisfy this rule. Optionally, a View button 69 is provided with the valid response drop down menu 69 which, when selected, displays the actual regular expression constraint for the rule. Also, a Failure message text box 71 may be optionally provided to display an error message to customers who provide order data in a format which does not meet the requirements of the rule. If desired, the user can be provided with the ability to edit the failure message. Additionally, a RIM Code field 73 is provided. Once editing of the rule has been completed, the user can save the changes by pressing the “Save” button 75 on the GUI.

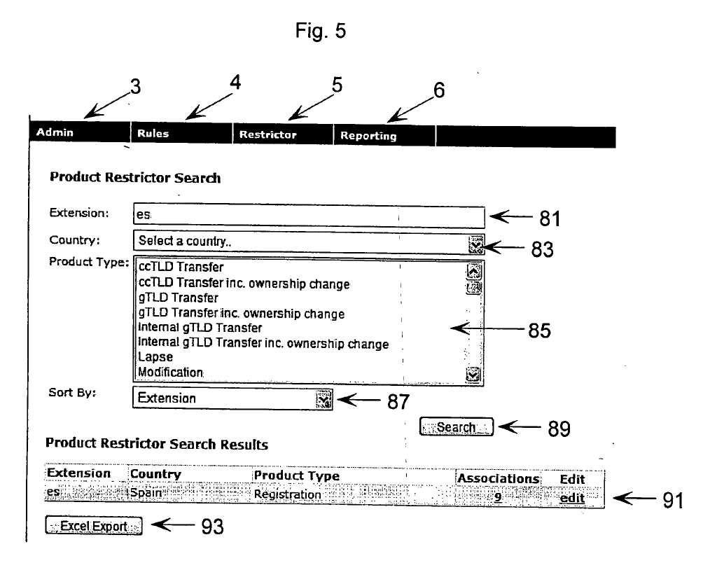

The Restrictor tab 5 of the GUI allows the user to browse the list of existing products and associate rules with a particular domain/product pair, or delete rules that have been already associated with a product. By selecting the Restrictor tab 5, the user is able to search for a product by domain extension, by country or by product type, as shown in FIG. 5. More particularly, an Extension field 81 is provided in which the user can search by domain extension; a Country drop down menu 83 is provided in which the user can search for a product by its associated country; and a Product Type list 85 is provided which allows the user to search for a domain by one or more product types. The search results can be sorted by extension name, by country or by product type using a “Sort By” drop down menu 87. A search is submitted by pressing the search button 89.

The search results are then displayed in table 91, in which the relevant domain extensions, countries associated with that extension and product type are provided. In this example, the domain extension “.es” was located by performing a search using the Extension field 81. An association's field is included in table 91 and indicates the number of rules associated with the particular domain/product pair. In this example, there are nine rules associated with the .es domain extension, each of which can be viewed by pressing a hyperlink provided in the association's field. The user can then associate rules with any domain/product pair on the list, or edit a domain/product pair that has already assigned rules by adding additional rules, or by deleting rules. This is done using the edit link. The results of the search can then be expanded to another application (e.g., Microsoft Excel®) using the Excel Export button 93.

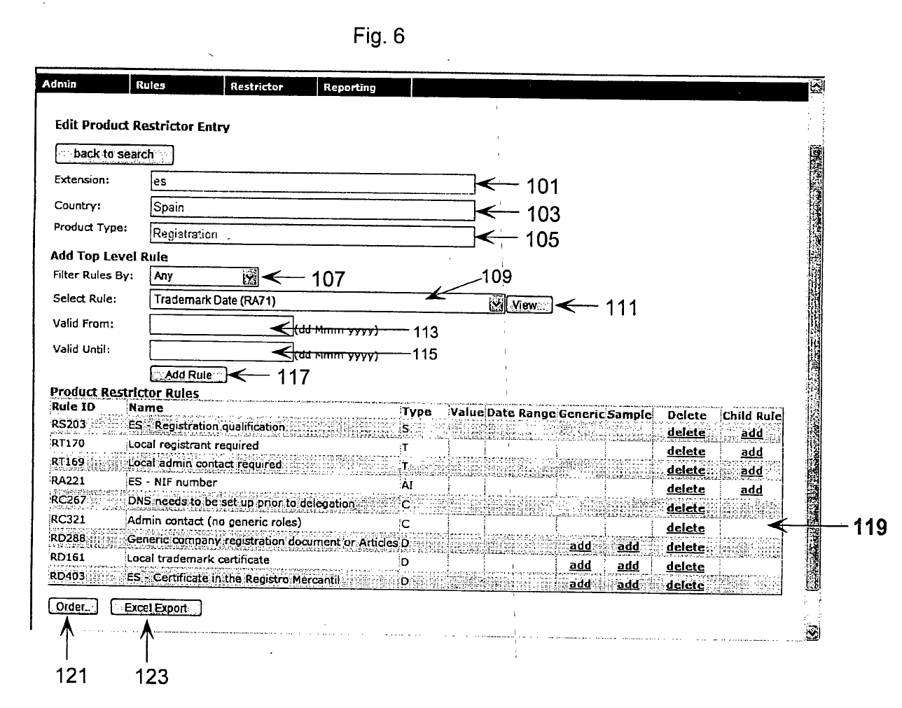

If the user chooses to edit a domain product pair that has already been assigned rules, an “Edit Product Restrictor Entry” page is displayed, as shown in FIG. 6. In this embodiment, the user has chosen to edit the domain extension “.es” from its search results. Information identifying this domain is displayed in Extension field 107, Country field 103 and the Product Type field 105. A user is able to associate a parent rule with the .es domain using an “Add Top Level Rule” feature, which in this embodiment, includes a drop down “Filter Rules By” menu 107. The menu 107 includes drop down choices for selecting template rules, additional information rules, check box rules, select-from rules and document rules, or all rules. Additionally, the Add Top Level Rule feature includes a Select Rule drop down menu 109 from which the user can select a particular rule to apply to the domain extension. If the user has selected a particular rule type (e.g., additional information) in the Filter Rules By drop down menu 107, then only the rules for that rule type will be available in the Select Rule drop down menu 109. A “View” button 111 is provided with the Select Rule drop down menu 109, which allows the user to view details pertaining to the rule selected (e.g., rule ID number, rule caption, etc.). Additionally, a Valid From field 113 and a Valid Until field 115 are optionally provided, which allow the user to specify dates for which the rule will apply to the domain extension. Once a rule is selected, it can be saved with the product by pressing the Add Rule button 117.

Additionally, a Product Restrictor Rules table 119 is provided in which each rule which has been associated with the domain is displayed. Table 119 includes information pertaining to each rule. In one embodiment, the Product Restrictor Rules table 119 includes fields containing the rule ID number (e.g., RS203, RT170, etc.), rule name (e.g., “ES-Registration qualification,” “Local registrant required,” etc.) and rule type (e.g., “T,” “S,” “AI,” “C,” and “D”) for each rule stored therein. Additionally, child rules associated with each rule on the list, if any, can be added by selecting an “add” hyperlink under the “Child Rule” caption. Additionally, a code which associates the child rule with one or more parent rules, if any, is displayed under the heading “Value.” Furthermore, the Date Range for which a rule is valid, if any, is displayed under the “Date Range” caption.

Documentation required by these rules is also displayed in table 119. In this regard, as shown in FIG. 6, the column labeled “Generic” allows the user to attach a generic document which meets the document rule on behalf of the customer. The “Sample” document column allows the user to associate a sample document with a document rule to specify to a customer an example of the type of document which would satisfy the relevant registry's requirement. Additionally, an Order button 121 is provided which enables a user to specify the order in which the rules are to be presented to a customer. An Excel Export button 123 is provided which allows the user to export the saved information to other applications (e.g., Microsoft Excel®).

Finally, the reporting tab 6 of the GUI allows the user to generate a customized list of domain/product pairs and their associated rules. More particularly, the Reporting tab allows the system administrator to access a reporting module through which rules related information can be extracted. A report can be generated by a search for domain extensions or by a search for a batch of domains in a free text box. Users can either view the results of the search or export them to a comma-separated variable file for conversion into a spreadsheet. The results will extract a consolidated report of all the extensions or domains, their related restrictions (rule name) and the associated constraints on those rules (e.g., date must be less than Dec. 30, 2002).

Once the rules have been associated with their relevant domain/product pairs, the software of the present invention interfaces the rules to a GUI, such as an Internet web page. The GUI and rules interact to guide a customer through the order entry process. The software used to accomplish this could be written in a variety of different languages, including, for example, ASP, Perl, ASP.net etc for web based applications. Java, C++, Visual Basic etc for desktop applications. The program instructions and routines for accomplishing this should be readily apparent to those skilled in the art.

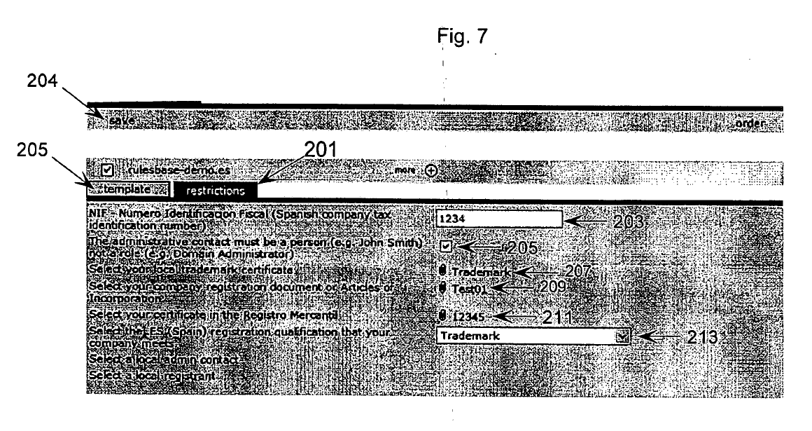

More particularly, a web page (not shown) is provided on which the customer can search for a particular domain extension (e.g., “.es”). Once a domain extension is located, a series of order entry rules are displayed which prompt a customer to enter information required by the registry for that domain, as shown in FIG. 7. More particularly, by way of example, the domain registry for the domain extension .es” requires that a customer provide its Spanish company tax identification number. Under a restrictions tab 201, the user is prompted to provide its tax ID number in a free text field 203. The response to this prompt is governed by additional information rules which specify, as a regular expression constraint, the acceptable format (e.g., four digits) of the customer's response. Additionally, a prompt is provided which requires that the customer confirm that his or her administrative contact is a person. To satisfy this rule, which is a check box rule, the customer must enter a check in the check box 205, confirming the administrative contact indeed has a local address. Additionally, the customer is prompted to select “Your local trademark certificate.” A paper clip icon 207 is provided, which enables the customer to satisfy this document rule by browsing his or her computer and attaching a trademark certificate. Additionally, the customer is prompted to select his or her “company registration document or articles of incorporation.” The user can satisfy this document rule by using a second paper clip icon 209, which allows the customer to browse his or her computer and attach the appropriate company registration document/article of incorporation. Likewise, the customer is prompted to attach a certificate in the “registrar mercantile,” as this is another requirement of the registry for the es domain extension. A third paper clip icon 211 is provided in which the customer can browse for this document in his or her computer and attach the appropriate document.

Additionally, the customer is prompted to “select the .es (Spain) registration qualification that your company meets.” To satisfy this select-from rule, a drop down menu 213 is provided in which the user can select-from any one of the following choices: Trademark; registered Spanish company name; and abbreviation of a Spanish company name.

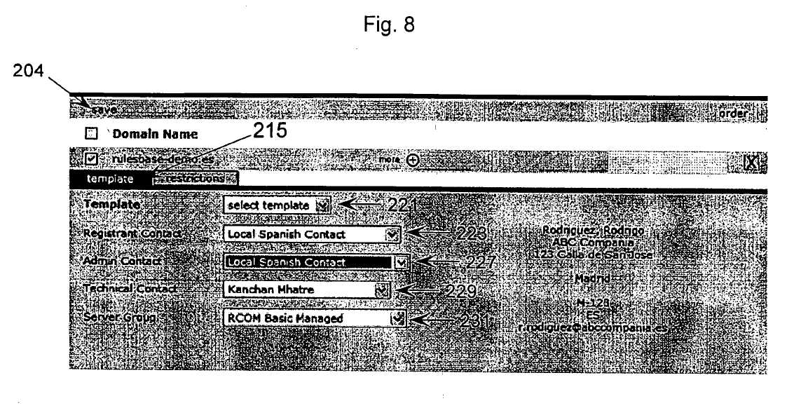

Additionally, the customer is prompted to select a local administrative contact and a local registrant. To satisfy these template rules, the user selects the template tab 215. This causes a “template” web page to be displayed as shown in FIG. 8. The template web page prompts the customer to provide “Registrant Contact” information, “Admin Contact” information, “Technical Contact” information and “Server Group” information. A template drop down menu 221 is provided which allows the customer to select which of these categories of information he or she would like to enter. As shown in FIG. 8, the customer has chosen to provide his or her Admin Contact information by selecting the Admin Contact drop down menu 227. Thereafter a series of text fields (not shown) are provided in which the user can enter the Admin Contact's name, address, e-mail address and other relevant information required by the relevant domain registry. This information is then stored and can be displayed by selecting the appropriate field (e.g., local Spanish contact) in the Admin Contact drop down menu 227. Similarly, Registrant Contact information can be provided by selecting this category in the template field 221 and then entering the Relevant Contact information in a series of similar text fields. This information is then saved and can be displayed by selecting the appropriate category on the Registrant Contact drop down menu 223.

Additionally, in this embodiment, the template page 215 is preconfigured with the name and address of a “technical contact” which is located at the registrar. This information can be displayed by selecting the technical contact option on the template drop down menu 221, and then selecting the appropriate name from the Technical Contact drop down menu 229. Likewise, the template page 215 can be preconfigured to include the name of the servers on which this information will be maintained (e.g., the registrar's server). In this regard, the user would select the server group option on the template drop down menu 221. To select the actual server for this category, the user would simply select an appropriate server from the server group drop down menu 231.

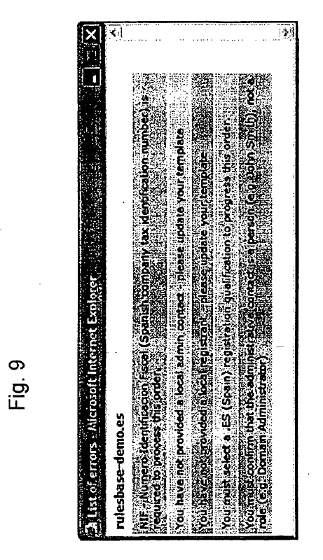

If the user has entered all the required information in the format required by each rule, then the order will be processed. If, on the other hand, the user has not met the requirements of one or more of these rules, an error message will be displayed indicating the nature of the error and how it should be corrected, such as the error messages shown in FIG. 9. Once the order is entered, the user can save the order by pressing a save button 204.

It should be understood that the foregoing description of FIGS. 1-9 are merely exemplary of the various ways in which the present invention can be implemented. Modifications to the user's GUI and order entry web pages can be made to suit the needs of the registrar and customer.

Now that the preferred embodiments of the present invention have been shown and described in detail, various modifications and improvements thereon will become readily apparent to those skilled in the art. For example, in some circumstances, a registry's rule for a particular category may be overly complicated and difficult for a customer to understand. For example, the registry for ES domain registrations require documentation to be completed in Spanish in a very specific manner. Failure to comply with the registry's guidelines results in a domain name application being rejected by the registry. Similarly, there are other registry requirements which do not necessarily need to be enforced when a customer is entering an order. For example, most ccTLD registries such as .FR, .AT, .DE, .ES and .NL require the name servers specified in the application template to be “set up” (e.g., preconfigured with a zone for the domain in question) before the relevant registry will approve the registration or modification. However, the customer may opt to designate its registrar's servers, and thus, would not have preconfigured a zone. In such situations, forcing customers to meet these rule requirements at the point of order entry could cause confusion and result in customer dissatisfaction. Accordingly, in one embodiment, the system of the present invention is configured such that the rule would not be satisfied by the customer but would rather be fulfilled by an employee of the registrar. Accordingly, the spirit and scope of the present invention is to be construed broadly and limited only by the appended claims and not by the foregoing specification.

What is claimed is:

1. A rule-based method for generating domain name orders in a specific format comprising the steps of:
creating a list of domain extensions which could be registered;
generating domain name order entry rules, wherein said rules comprise constraints which require domain order information to be provided in a format required by at least one registry of a domain on said list of domains;
storing said set of rules separate from said list of domains; and
associating any of said rules with at least one domain in said list of domains.

2. The method of claim 1, wherein said set of rules and said list of domains are stored in storage media on a server.

3. The method of claim 2, wherein said storage media comprises one or more of the following: a relational database; an XML file and an object oriented class.

4. The method of claim 1, wherein said set of rules are written in an object oriented language.

5. The method of claim 4, wherein said object oriented language comprises one or more of the following: an application program interface; Java; and C++.

6. The method of claim 1, further comprising the step of searching for at least one domain extension stored in said list of domains.

7. The method of claim 6, wherein said step of searching further comprises the step of searching by one or more of the following criteria: domain extension; country; and product type.

8. The method of claim 1, wherein said list of domains further comprises at least one domain extensions associated with at least one product type.

9. The method of claim 8, wherein said at least one product type comprises one or more of the following: registrations of domains; renewals of registrations; modifications to existing registrations; lapses in registrations; gTLD transfers in; ccTLD transfers in; and transfers out.

10. The method of claim 1, further comprising the step of updating said list of domains with domains extensions not previously stored on said list of domains.

11. The method of claim 1, further comprising the step of editing said list of domains.

12. The method of claim 11, wherein said step of editing further comprises the step of associating at least one rule with a domain extension stored in said list of domains.

13. The method of claim 11, wherein said step of editing further comprises the step of removing at least one rule associated with a domain extension stored in said list of domains.

14. The method of claim 1, further comprising the step of organizing said set of rules by rule types.

15. The method of claim 14, wherein said rules types comprises one or more of the following categories: template rules; additional information rules; select-from rules; document rules; and check-box rules.

16. The method of claim 15, wherein said template rules comprise constraints on the manner in which Whois information can be entered by a domain name applicant.

17. The method of claim 16, wherein said Whois information comprises one or more of the following categories of information: registrant name; administrative contact; technical contact; and billing information.

18. The method of claim 1, further comprising the step of storing at least one generic rule in said set of rules, wherein said at least one generic rule comprises constraints which are required by at least two registries.

19. The method of claim 15, wherein said document rules comprise constraints on the manner in which documents can be provided by a domain name applicant.

20. The method of claim 19, wherein said document rules permit a domain name applicant to browse a computer for a document.

21. The method of claim 19, further comprising the step of associating a sample document with at least one document rule.

22. The method of claim 15, wherein said additional information rules comprise constraints on the manner in which additional information can be provided by a domain name applicant.

23. The method of claim 22, wherein said additional information comprises one or more of the following categories of information: trademark name; trademark registration date; trademark registration number; company registration number; and an authorization code.

24. The method of claim 15, further comprising the step of associating a label with at least one additional information rule.

25. The method of claim 22, wherein said constraints are regular expression constraints.

26. The method of claim 15, wherein said select-from rules require a domain name applicant to select from one or more pre-configured responses when providing information in a domain name application.

27. The method of claim 26, wherein said one or more preconfigured responses are provided in a drop-down menu.

28. The method of claim 27, further comprising the step of assigning a description and code value to at least one select-from rule.

29. The method of claim 15, wherein said check-box rules require a domain name applicant to check a box confirming information when ordering a domain name application.

30. The method of claim 1, wherein said set of rules are organized as a hierarchy of components and subcomponents.

31. The method of claim 30, wherein said components comprise at least one parent rule and said subcomponents comprise at least one child rule associated with said parent rule.

32. The method of claim 1, wherein said set of rules is organized by rule identification number, rule name, rule type and domain extensions associated each rule stored in said set of rules.

33. The method of claim 1, further comprising the step of searching for at least one rule stored in said set of rules.

34. The method of claim 33, wherein said step of searching further comprises the step of searching by one or more of the following criteria: rule name; rule identification number; and rule type.

35. The method of claim 1, further comprising the step of creating at least one new rule.

36. The method of claim 1, further comprising the step of editing at least one rule stored in said set of rules.

37. The method of claim 36, wherein said step of editing further comprises one or more of the following steps: creating a new rule identification number; indicating a format of a valid response to said new rule; and placing a constraint on said response to said rule.

38. A rule-based system for generating domain name orders in a specific format comprising:
a server interfaced to a network, wherein said server comprises storage media;
a list of domain extensions stored on said storage media,
domain order entry rules stored separately from said list of domain extensions on said storage media, wherein said rules comprise constraints which ensure that a registrant provides information in a format required by at least one registry of a domain on said list of domains; and
a graphical user interface for creating and editing said rules and said list of domains.

39. The system of claim 38, further comprising a graphical user interface for guiding a domain name registrant through an order entry process.

40. The system of claim 38, wherein said storage media comprises one or more of the following: a relational database; an XML file and an object oriented class.

41. The system of claim 38, wherein said set of rules are written in an object oriented language.

42. The system of claim 41, wherein said object oriented language comprises one or more of the following: an application program interface; Java; and C++.

43. The system of claim 38, further comprising a search filter for searching said list of domain extensions.

44. The system of claim 39, wherein said search filter is configured to search said list of domain extensions by one or more of the following criteria: domain extension; country; and product type.

45. The system of claim 38, wherein said list of domains further comprises at least one domain extensions associated with at least one product type.

46. The system of claim 45, wherein said at least one product type comprises one or more of the following: registrations of domains; renewals of registrations; modifications to existing registrations; lapses in registrations; gTLD transfers in; ccTLD transfers in; and transfers out.

47. The system of claim 38, wherein at least one rule is associated with at least one domain extension.

48. The system of claim 38, wherein said rules are organized by rule types.

49. The system of claim 48, wherein said rules types comprises one or more of the following categories: template rules; additional information rules; select-from rules; document rules; and check-box rules.

50. The system of claim 49, wherein said template rules comprise constraints on the manner in which Whois information can be entered by a domain name applicant.

51. The system of claim 50, wherein said Whois information comprises one or more of the following categories of information: registrant name; administrative contact; technical contact; and billing information.

52. The system of claim 49, wherein said document rules permit a domain name applicant to browse a computer for a document.

53. The system of claim 49, wherein said additional information rules comprise constraints on the manner in which additional information can be provided by a domain name applicant.

54. The system of claim 53, wherein said additional information comprises one or more of the following categories of information: trademark name; trademark registration date; trademark registration number; company registration number; and an authorization code.

55. The system of claim 49, further comprising the step of associating a label with at least one additional information rule.

56. The system of claim 53, wherein said constraints are regular expression constraints.

57. The system of claim 49, wherein said select-from rules require a domain name applicant to select from one or more pre-configured responses when providing information in a domain name application.

58. The system of claim 57, wherein said one or more preconfigured responses are provided in a drop-down menu.

59. The system of claim 57, further comprising the step of assigning a description and code value to at least one select-from rule.

60. The system of claim 49, wherein said check-box rules require a domain name applicant to check a box confirming information when ordering a domain name application.

61. The system of claim 38, wherein said rules are organized as a hierarchy of components and subcomponents.

62. The system of claim 61, wherein said components comprise at least one parent rule and said subcomponents comprise at least one child rule associated with said parent rule.

63. The system of claim 38, wherein said rules are organized by rule identification number, rule name, rule type and domain extensions associated each rule stored in said set of rules.

64. The system of claim 38, further comprising a search filter for searching for at least one rule stored in said storage media.

65. The system of claim 64, wherein said search filter is configured to search the rules stored in said storage media by one or more of the following criteria: rule name; rule identification number; and rule type.

66. A graphical user interface for associating domain extension order entry rules with domain extensions comprising:
a domain extension page for creating and editing a list of domain extensions which can be registered, wherein said domain extension page is interfaced to a list of domain extensions stored on a server; and
a rules page for creating and editing rules which govern the manner in which domain name order data can be provided, wherein
said rules page is interfaced to a table of rules stored on said server, and
said rules page is configured to associate a rule stored in said table of rules with domain stored said list of domain extensions.

67. The graphical user interface of claim 66, wherein said rules page further comprises a search field for searching for at least one rule stored in said table of rules.

68. The graphical user interface of claim 67, wherein said search field is configured to search the table of rules by one or more of the following criteria: rule identification number; rule name and rule type.

69. The graphical user interface of claim 68, wherein said rule type comprises one or more of the following categories: template rules; document rules; additional information rules; select-from rules; and check-box rules.

70. The graphical user interface of claim 66, wherein said rules page further comprises an editable rule caption field.

71. The graphical user interface of claim 66, wherein said rules page further comprises a notes field for associating comments with a particular rule.

72. The graphical user interface of claim 66, wherein said rules page further comprises at least one check-box for indicating whether a domain name application must satisfy a particular rule.

73. The graphical user interface of claim 66, wherein said rules page further comprises a drop-down menu from which a user can indicate whether a particular rule must be satisfied by a domain name applicant or some other person.

74. The graphical user interface of claim 66, wherein said rules page further comprises a drop-down menu from which a user can select a valid response to a particular rule.

75. The graphical user interface of claim 66, wherein said rules page further comprises an editable error message field.

76. The graphical user interface of claim 66, wherein said rules page further comprises a field for associating at least one rule stored in table of rules with at least one domain extension stored in said list of domain extensions.

77. The graphical user interface of claim 66, wherein said domain extension page further comprises a search field for searching for at least one domain extension stored in said list of domain extensions.

78. The graphical user interface of claim 77, wherein said search field is configured to search the list of domain extensions by one or more of the following criteria: domain extension; countries; and product types.

79. The graphical user interface of claim 78, wherein said at product types comprise one or more of the following: registrations of domains; renewals of registrations; modifications to existing registrations; lapses in registrations; gTLD transfers in; ccTLD transfers in; and transfers out.

80. The graphical user interface of claim 66, wherein said rules page further comprises a field for associating at least one domain extension stored in said list of domain extensions with at least one rule stored in table of rules.

81. The graphical user interface of claim 80, wherein said field for associating further comprises a drop-down menu for selecting a rule type to associate with a particular domain extension.

82. The graphical user interface of claim 81, wherein rule type comprises one or more of the following: template rules; document rules; additional information rules; select-from rules; and check-box rules.

83. The graphical user interface of claim 80, wherein said field for associating further comprises a drop-down menu for selecting a particular rule to associate with a particular domain extension.

84. The graphical user interface of claim 83, further comprising a view button to view details pertaining to the particular rule selected from the drop-menu.

85. The graphical user interface of claim 66, wherein said domain extension page further comprises fields for placing date constraints on a particular rule being associated with a particular domain extension.

86. The graphical user interface of claim 66, further comprising a field for associating a child rule with a parent rule that has been associated with a particular domain extension.

87. The graphical user interface of claim 66, further comprising a field for associating a document with a particular domain extension.

88. The graphical user interface of claim 66, further comprising a reporting page of generating a customized report of domain extensions and their associated rules.

89. The graphical user interface of claim 88, wherein said reporting page is interfaced to a reporting module.

90. The graphical user interface of claim 66, further comprising an administrative page for performing one or more of the following functions: adding new domain extensions to said list of domains; adding regular expression constraints to said table of rules; creating check-boxes; mapping template fields for a particular template rule; and associating a select-from rule with a drop-down menu.

91. A graphical user interface for entering a domain name order comprising:
a search page for searching for at least one domain extension to be registered; and
a page for entering domain order information for a domain to be registered, wherein
said page for entering domain order information is interfaced to a list of
rules associated with the domain to be registered, and
said page for entering domain order information comprises at least one prompt which require a domain name applicant to comply with rules on the list of rules to complete a domain name order.

92. The graphical user interface of claim 91, wherein said at least one prompt comprises a prompt to comply with at least one template rule.

93. The graphical user interface of claim 91, wherein said at least one prompt comprises a prompt to comply with at least one additional information rule.

94. The graphical user interface of claim 91, wherein said at least one prompt comprises a prompt to comply with at least one document rule.

95. The graphical user interface of claim 91, wherein said at least one prompt comprises a prompt to comply with at least one select-from rule.

96. The graphical user interface of claim 91, wherein said at least one prompt comprises a prompt to comply with at least one check-box rule.

97. The graphical user interface of claim 91, further comprising an error message page for prompting a domain name applicant to correct any errors made during the order entry process.
